(19) United States
(12) Patent Application Publication
(10) Pub. No.: US 2013/0021320 A1
(43) Pub. Date: Jan. 24, 2013

(54) PIXEL ELEMENT, DISPLAY PANEL THEREOF, AND CONTROL METHOD THEREOF

(71) Applicant: Keitaro Yamashita, Hyogo (JP)

(72) Inventor: Keitaro Yamashita, Hyogo (JP)

(73) Assignee: CHIMEI INNOLUX CORPORATION, Chu-Nan (TW)

(21) Appl. No.: 13/185,411

(22) Filed: Jul. 18, 2011

(51) Int. Cl. G09G 5/00

(52) U.S. Cl. 345/214

(57) ABSTRACT

A pixel element, a display panel, and a control method thereof are provided. The method includes a number of steps. An image data is stored in an image data storage capacitor of the display panel. A sample operation is performed to store the image data in a capacitive element.

Based on the stored image data in the capacitive element, a refresh operation is performed to refresh the image data stored in the image data storage capacitor. The refreshed image data has the same polarity as the polarity of the image data stored in the image data storage capacitor in the sample operation.

### BACKGROUND OF THE INVENTION

1. Field of the Invention

The invention relates in general to a pixel element, a display panel, and a control method thereof, and more particularly to a pixel element, a display panel, and a control method thereof for power reduction.

2. Description of the Related Art

Display devices have been widespread used in a variety of application, such as lap-top computers, mobile phones, or personal digital assistants. In such devices, reduction of power consumption is an important issue since the power consumption has a direct impact on the operation time of the display devices.

As to an active matrix pixel array of display devices, the active matrix pixel array usually includes a number of gate lines, a number source lines, and a number of pixel elements arranged in a matrix. Each pixel element includes a capacitor and a thin film transistor (TFT). The TFT, when activated via one of the gate lines, transfers an image data from a corresponding source line to the capacitor. However, in the course of transferring the image data to the capacitor, parasite capacitances existing in the intersection of the source lines and gate lines of the active matrix pixel array are charged and discharged numerous times, resulting in a great deal of power consumption.

Besides, as to a liquid crystal display, when the image data stored in the capacitor is refreshed, the polarity of the image data is regularly inversed to prevent degradation of the liquid crystal (LC) material. This also increases power consumption since the capacitor is charged and discharged numerous times to frequently change its voltage polarity. Therefore, it is an important issue to reduce power consumption in displaying.

### SUMMARY OF THE INVENTION

The invention is directed to a pixel element, a display panel, and a control method thereof, in which the power consumption can be reduced.

According to an aspect of the present invention, a pixel element is provided for use in an active matrix pixel array. The pixel element includes an image data storage capacitor, a gate switch, and a refresh unit. The refresh unit includes a first to third switches, and a capacitive element. The image data storage capacitor is for storing an image data. The gate switch has a control terminal coupled to a corresponding gate line. The gate switch is coupled between a corresponding source line and the image data storage capacitor. The first switch has a control terminal for receiving a sample control signal. The capacitive element has a first terminal coupled via the first switch to a pixel electrode of the image data storage capacitor. The capacitive element has a capacitance varied with the applied voltage across the capacitive element. The second switch has a control terminal coupled to the first terminal of the capacitive element. The third switch has a control terminal for receiving a refresh control signal. The third switch and the second switch are serially coupled with each other. The second switch and third switch are coupled between the corresponding source line and the image data storage capacitor for receiving a refresh data signal.

According to another aspect of the present invention, a control method for use in an active matrix pixel array is provided. The method includes a number of steps. An image data is stored in an image data storage capacitor of an active matrix pixel array. A sample operation is performed to store the image data in a capacitive element. Based on the stored image data in the capacitive element, a refresh operation is performed to refresh the image data stored in the image data storage capacitor. The refreshed image data has the same polarity as the polarity of the image data stored in the image data storage capacitor in the sample operation.

According to another aspect of the present invention, a display panel is provided. The display panel includes an active matrix pixel array, a source driver, and a gate driver. The active matrix pixel array includes gate lines, source lines, and pixel elements. The pixel elements are arranged in a matrix. Each pixel element is coupled to the corresponding gate line and source line. Each pixel element is aforementioned. The source driver drives the source lines. The gate driver drives the gate lines.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram showing an example of a display panel.

FIG. 2 is a block diagram showing a portion of the pixel element of the display panel in FIG. 1 according to an embodiment of the invention.

FIG. 3A is a schematic diagram showing an example of the capacitive element in FIG. 2.

FIG. 3B is a plot diagram showing the characteristic relationship between the capacitance of the capacitive element in FIG. 3A and an applied voltage provided thereacross.

FIG. 4A is a circuit diagram showing an example of a pixel element in FIG. 1 according to an embodiment of the invention.

FIGS. 4B and 4C are timing diagrams each showing a number of signal waveforms that the display panel uses to execute a control method according to an embodiment of the invention.

FIG. 5A is a timing diagram showing a number of signal waveforms when the display panel executes the second refresh scheme during a refresh period in the refresh mode.

FIG. 5B is a timing diagram showing a number of signal waveforms when the display panel executes a combined refresh scheme during the same refresh period in the refresh mode according to one embodiment of the invention.

FIGS. 6-9 are circuit diagrams each showing an example of the pixel element in FIG. 4A according to another embodiment of the invention.

### DETAILED DESCRIPTION OF THE INVENTION

A display panel, a pixel element and a control method thereof are provided in a number of embodiments of the invention as follows. The display panel is adapted of being operated at two modes, one of which is, for example, an active mode such as the video mode of a display device, while the other is, for example, a passive or refresh mode such as a standby mode of an electronic device including the active matrix display device. When being operated at the active mode, the active matrix display device writes image data in the pixel element. When being operated at the refresh mode, the active matrix display device allows the pixel element to refresh its stored image data, i.e., to maintain the image data of the pixel element, thus generating a constant output such as static image over a prolonged period of time.

According to an embodiment of the invention, the control method is for use in the active matrix pixel array, and includes a number of steps as follows. An image data is stored in an image data storage capacitor of the active matrix pixel array. A sample operation and a refresh operation are performed on the image data storage capacitor. When the refresh operation is performed, the image data stored in the image data storage capacitor is refreshed, and the refreshed image data has the same polarity as the polarity of the image data stored in the image data storage capacitor in the sample operation. In this way, the image data storage capacitor can have its stored image data refreshed while the polarity of the image data remained. This means that the image data storage capacitor can be prevented from being charged and discharged numerous times, so that power consumption can be reduced.

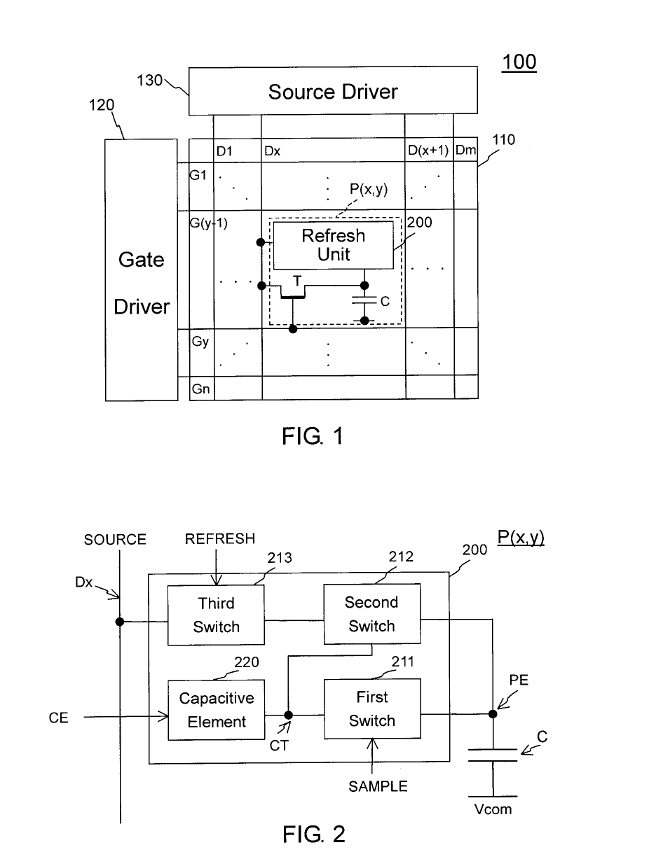

FIG. 1 is a block diagram showing an example of a display panel. The display panel 100 at least includes an active matrix pixel array 110, a gate driver 120, and a source driver 130. The display panel 100 can be used in display devices. The active matrix pixel array 110 includes a number of gate lines G1-Gn and a number of source lines D1-Dm. The gate driver 120 drives the scan lines G1-Gn. The source driver 130 drives the source lines D1-Dm. The active matrix pixel array 110 further includes a number of pixel elements arranged in a matrix and each being coupled to the corresponding gate line and the corresponding source line. As is made as an example, a pixel element P(x,y) includes an image data storage capacitor C, a gate switch T, and a refresh unit 200 according to an embodiment of the invention. The gate switch T has a control terminal coupled to the corresponding gate line Gy, and is coupled between the corresponding source line Dx and the image data storage capacitor C. The refresh unit 200 is coupled between the corresponding source line Dx and the image data storage capacitor C.

FIG. 2 is a block diagram showing a portion of the pixel element of the display panel in FIG. 1 according to an embodiment of the invention. In this example, the refresh unit 200 includes a first switch 211, a second switch 212, a third switch 213, and a capacitive element 220. The first switch 211 has a control terminal for receiving a sample control signal SAMPLE. The second switch 212 has a control terminal coupled to a first terminal (denoted as a node of CT) of the capacitive element 220. The third switch 213 has a control terminal for receiving a refresh control signal REFRESH. The third switch 213 and the second switch 212 are serially coupled with each other.

The second switch 212 has a terminal coupled to a pixel electrode (denoted as a node of PE) of the image data storage capacitor C, and the third switch 213 has a terminal for receiving a refresh data signal SOURCE. The capacitive element 220 has the first terminal CT coupled to the pixel electrode PE of the image data storage capacitor C via the first switch 211. The capacitive element 220 further has a second terminal for receiving an enable signal CE.

In an embodiment, the sample control signal SAMPLE and the refresh data signal REFRESH are sequentially enabled. In response thereto, the refresh unit 200 performs a sample operation and a refresh operation, respectively. In the sample operation, the capacitive element 220 is used for storing the image data of the image data storage capacitor C. The capacitive element 220 preferably can be implemented as having a smaller capacitance than that of the image data storage capacitor C, preventing the image data stored in the image data storage capacitor C from being significantly affected in the sample operation. The capacitive element 220 is regarded as a memory for storing the data of the image data storage capacitor C. The stored data in the capacitive element 220 is used to control the second switch 212, so as to determine whether or not a refresh voltage such as the refresh data signal SOURCE is provided to refresh the image data storage capacitor C in the refresh operation. This renders the pixel element P(x,y) to become a self-refreshing memory in pixel (MIP). With the MIP, the active matrix pixel array can be operated similarly based on a DRAM concept and suitable for high resolution display such as high end smart phone or e-reader applications.

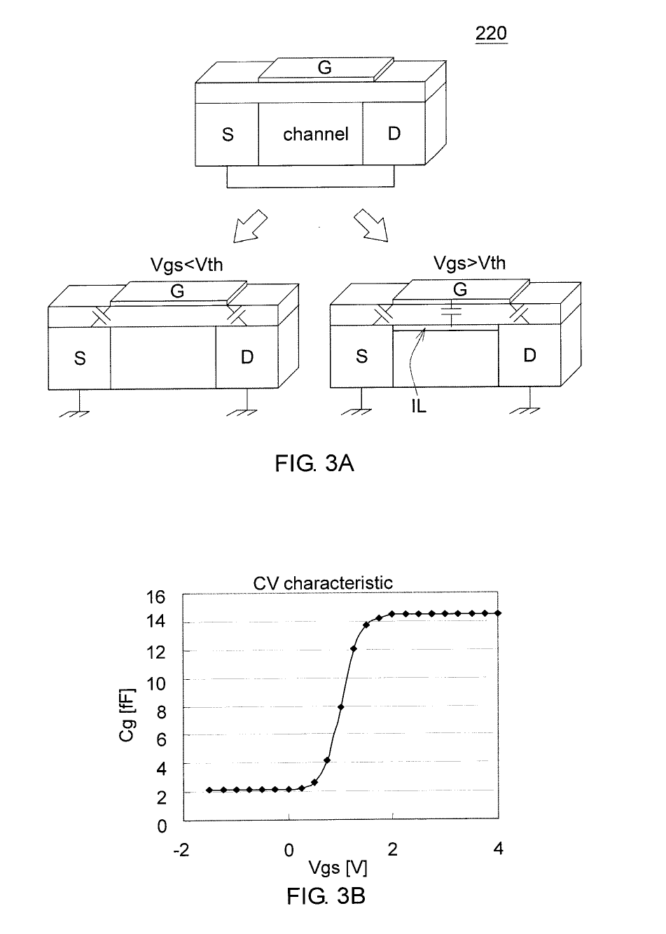

The capacitive element 220 has its capacitance varied with the applied voltage across the capacitive element 220. The capacitive element 220 can be referred to as a voltage dependent capacitor whose capacitance is varied with an applied voltage across its two terminals. An example of the capacitive element 220 is made with reference to FIGS. 3A and 3B.

FIG. 3A is a schematic diagram showing an example of the capacitive element in FIG. 2. FIG. 3B is a plot diagram showing the characteristic relationship between the capacitance of the capacitive element in FIG. 3A and an applied voltage provided thereacross. In this example, the capacitive element 220 is implemented by a thin film transistor having a source terminal S and a drain terminal D electrically connected with each other. The capacitance Cg of the capacitive element 220 is varied with an applied voltage Vgs across its control terminal G and source terminal S as shown in FIG. 3B. As can be seen from FIG. 3B, the capacitive element 220 has a transition state where its capacitance Cg is significantly varied with the applied voltage Vgs thereacross. Specifically, in a case that the applied voltage Vgs is lower than a threshold voltage Vth, the channel between source terminal S and drain terminal D is nonconductive, and the capacitive element 220 is in, for example, turn-off state and has a smaller capacitance Cg related to fringe capacitors existed between gate terminal G and each of source terminal S and drain terminal D. On the other hand, in a case that the applied voltage Vgs is higher than the threshold voltage Vth, an inversion layer IL is formed with electrons accumulated on the channel surface. Since the inversion layer IL is conductive, the capacitive element 220 is in, for example, turn-on state and has a larger capacitance Cg which takes into account the coupling capacitor between the gate terminal G and the inversion layer IL.

In an embodiment, the applied voltage across the capacitive element 220 is determined by the enabled signal CE and the image data stored in the image data storage capacitor C. Depending on the image data of binary high or binary low, the enabled signal CE can be disabled at a level that allows the capacitive element 220 to be selectively operated at turn-on state or turn-off state, thus revealing obvious capacitance variance. The difference of the capacitances causes the refresh unit 200 to be operated differently.

Based on the CV (capacitance and voltage) characteristic of the capacitive element 220, the refresh unit 200 refreshes the image data stored in the image data storage capacitor C in the refresh operation. In an embodiment, the refreshed image data has the same polarity as the polarity of the image data stored in the image data storage capacitor C in the sample operation. Exemplary configurations and the further description are described as follows.

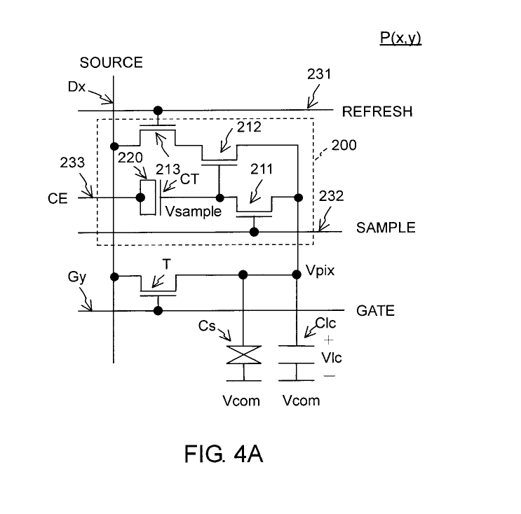

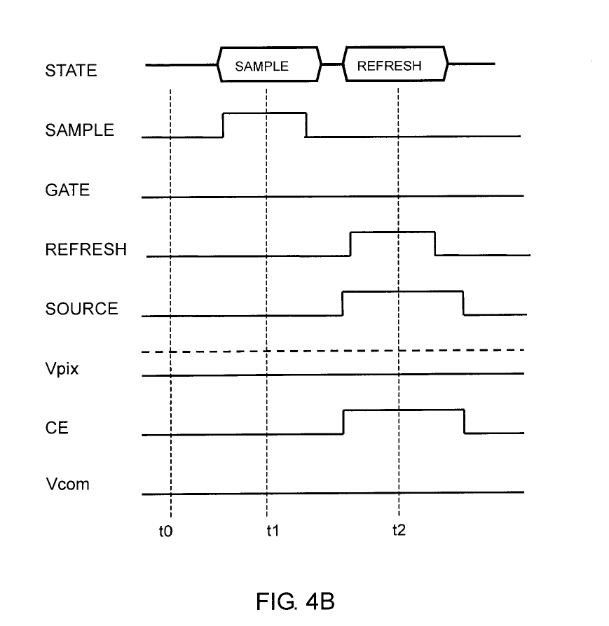

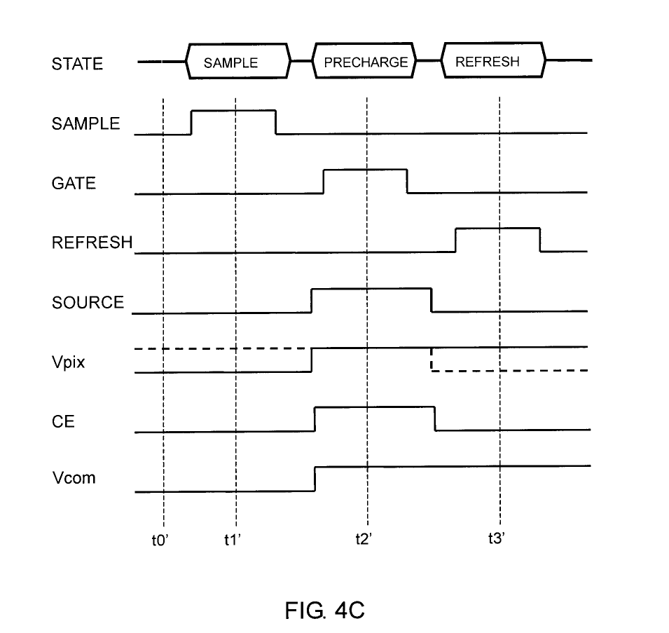

FIG. 4A is a circuit diagram showing an example of a pixel element in FIG. 1 according to an embodiment of the invention. In this example, the first to third switches 211-213 of the refresh unit 200 are exemplified as being implemented by n-type thin film transistors. The capacitive element 220 is an n-type thin film transistor having a control terminal serving as the first terminal CT. The second switch 212 is coupled between the third switch 213 and the image data storage capacitor C. The image data storage capacitor C is exemplarily represented by a combination of two capacitors such as a liquid crystal capacitor Clc and a storage capacitor Cs. The refresh data signal SOURCE is provided from the corresponding source line Dx; a gate control signal GATE is provided from the corresponding gate line Gy; the refresh control signal REFRESH, the sample control signal SAMPLE, and the enable signal CE are provided from additional transmission lines 231-233, respectively.

The operation of the pixel element in FIG. 4A, thus, is provided with reference to FIGS. 4B and 4C, which are timing diagrams each showing a number of signal waveforms that the display panel uses to execute a control method according to an embodiment of the invention. There are two refresh schemes for refreshing the image data stored in the image data storage capacitor C.

### First Refresh Scheme

A first refresh scheme is provided with reference to both FIGS. 4A and 4B. In the first refresh scheme, the sample control signal SAMPLE and the refresh data signal SOURCE are sequentially enabled, and the refresh unit 200 performs a sample operation and a refresh operation on the image data storage capacitor C, respectively. The to-be-refreshed image data can be of one of two voltages, 5V or 0V.

In the first refresh scheme, the image data of 5V is refreshed while its polarity remained, e.g., “Vpix, Vcom”=“5V, 0V” to “5V, 0V”.

First, refer to a time t0 where the pixel voltage Vpix is initially 5V (shown in dashed line) and the common voltage Vcom is initially 0V, indicating that the image data stored in the image data storage capacitor C is 5V. Then, refer to a time t1 where a sample operation is performed. The sample control signal SAMPLE is enabled at a high level to turn on the first switch 211. Via the turn-on first switch 211, the first terminal of the capacitive element 220 (the control terminal of the TFT in this example) is biased at a substantially same level of the current pixel voltage Vpix. This means that the pixel voltage Vpix is sampled as a sample voltage Vsample and stored in the capacitive element 220, i.e., Vsample=5V. The enable signal CE is disabled at a low level of, for example, 0V. In this situation, the applied voltage across the capacitive element 220 is 5V (=Vsample−CE(t1)=5V−0V), higher than the threshold voltage of the capacitive element 220 which is about 1V. Therefore, the capacitive element 220 has a large capacitance, such as 10 fF. After the time t1, the sample control signal SAMPLE is disabled at a low level. Due to feed-through effect from the first switch 211, the sample voltage Vsample has a small voltage drop of, for example, 0.5V in this situation since the capacitive element 220 has a large capacitance. At this time, the sample voltage Vsample is about 4.5V (=5V−0.5V).

After that, the source data signal SOURCE is enabled at a high level of, for example, 5V. The enable signal CE is enabled from a low level to a high level of, for example, from 0V to 3V. The different between the low level and the high level of the enabled signal CE is, in this example, 3V, higher than the threshold voltage of the second switch 212, so as to compensate for the threshold voltage of the second switch 212. The enable signal CE pushes up the sample voltage Vsample to about 7.5V (=4.5V+3V) via the capacitive element 220. Between the sample voltage Vsample and the pixel voltage Vpix, there is a voltage difference of 2.5V (Vsample−Vpix=7.5V−5V) higher than the threshold voltage of 1V of the second switch 212, so that the second switch 212 is turned on.

Then, refer to a time t2 where a refresh operation is performed. The refresh control signal REFRESH is enabled at a high level to turn on the third switch 213. The second switch 212 is still turned on at the time t2. Via the turn-on second and third switches 212 and 213, the enabled refresh data signal SOURCE of 5V is provided to refresh the pixel voltage Vpix which may have decayed due to TFT leakage current. Meanwhile, the common voltage Vcom is remained at a low level of, for example, 0V. Thus, as can be seen from time t1 and time t2 in FIG. 4B, when the refresh operation in the first refresh scheme is performed, the refreshed image data at time t2 (“Vpix, Vcom”=“5V, 0V”) has the same polarity as the polarity of the image data at time t1 (“Vpix, Vcom”=“5V, 0V”).

In the first refresh scheme, the image data of 0V is refreshed while its polarity remained, e.g., “Vpix, Vcom”=“0V, 0V” to “0V, 0V”.

Similar operation can be referred to the image data of 5V in previous description, and is omitted for the sake of brevity. First, refer to the time t0 where the pixel voltage Vpix is initially 0V (shown in solid line) and the common voltage Vcom is initially 0V, indicating that the image data stored in the image data storage capacitor C is 0V. Then, refer to the time t1. The sample control signal SAMPLE is enabled to turn on the first switch 211, and the first terminal CT of capacitive element 220 is biased at 0V. This means that the sample voltage Vsample is at low level, Vsample=0V. The enable signal CE is disabled at a low level of 0V, so that the applied voltage across the capacitive element 220 is 0V, lower than the threshold voltage of the second switch 212 which is about 1V. Therefore, the capacitive element 220 has a small capacitance, such as 2 fF. In this situation, when the sample control signal SAMPLE is disabled, a significant voltage drop of, for example 5V, is generated on the sample voltage Vsample due to feed-through effect from the first switch 211. At this time, the sample voltage Vsample is about −5V (=0V−5V).

After that, the enable signal CE is enabled at an enabled level of 3V, pushing up the sample voltage Vsample to about −2V (=−5V+3V) via the capacitive element 220. At this time, the second switch 212 is turned off since the voltage difference of −2V (Vsample−Vpix=−2V−0V) is lower than its threshold voltage of 1V.

Then, refer to the time t2. The refresh control signal REFRESH is enabled at a high level to turn on the third switch 213. At this time, because the second switch 212 is turned off, the refresh data signal SOURCE of 5V is not provided to refresh the pixel voltage Vpix of 0V, and the pixel voltage Vpix of 0V can be remained around 0V. Thus, as can be seen from time t1 and time t2 in FIG. 4B, when the refresh operation is performed in the first refresh scheme, the refreshed image data at time t2 (“Vpix, Vcom”=“0V, 0V”) has the same polarity as the polarity of the image data at time t1 (“Vpix, Vcom”=“0V, 0V”).

For the image data of 0V, maintaining the pixel voltage at 0V is further explained as follows. As to the image data of 0V, the pixel voltage Vpix of 0V can be isolated from the source line Dx in the first refresh scheme. It can be seen that the pixel voltage of 0V may be inevitably, gradually shifted due to a leakage current though TFTs such as switches 212 and 213. This voltage shift caused by TFT leakage current can be stopped by equalizing the voltage on the source line Dx to 0V, e.g., by applying 0V on the source line Dx. In an embodiment related to FIG. 4B, the refresh data signal SOURCE is kept at 0V for a longer, dominated period than at 5V, for example but non-limitedly a period of 100 ms, while the time duration of sample and refresh operations in the first refresh scheme is a relatively short period such as 5 ms. In this way, the amount of charges fed into the pixel is small enough to be neglected. Therefore, the pixel voltage of 0V can be maintained at 0V.

According to the first refresh scheme for use in image data of 5V and 0V, when the refresh operation is performed, the refreshed image data has the same polarity as the polarity of the image data stored in the image data storage capacitor C in the sample operation (“Vpix, Vcom”=“5V, 0V” to 5V, 0V” and “Vpix, Vcom”=“0V, 0V” to “0V, 0V”). In this way, the power is consumed at restoring the charges leaked away. Such power consumption is usually low because restoring the image data for its leaked charges consumes less power than does inversing the polarity of the image data.

Moreover, as to the pixel voltage Vpix of 0V in the first refresh scheme, the second switch 212 is always turned off to isolate the image data storage capacitor C from the source line Dx, so that a same voltage can be transferred from the source line Dx during the refresh operation, regardless of what the data stored in the image data storage capacitor C is. As such, the first refresh scheme can make use of the same group of signals to refresh the image data of 5V and 0V, so that the complexity of driving the display panel can be reduced.

### Second Refresh Scheme

A second refresh scheme is provided with reference to both FIGS. 4A and 4C. In the second refresh scheme, the sample control signal SAMPLE, the gate control signal GATE, and the refresh data signal SOURCE are sequentially enabled. In response thereto, the refresh unit 200 and the gate switch T perform a sample operation, a precharge operation, and a refresh operation on the image data storage capacitor C, respectively. The second refresh scheme differs with the first refresh scheme in that the common voltage Vcom is flipped, e.g., converted from 0V to 5V in this case, in order to refresh the image data with inversing its polarity. In addition, the enable signal CE is disabled at a first level of, for example, −8V, and enabled at a second level of, for example, −5V. These levels are configured to be lower than the pixel voltage of 5V or 0V, turning the capacitive element 220 into a capacitor having a fixed large capacitance according to the CV characteristic in FIG. 3B.

In the second refresh scheme, the image data of 5V is refreshed while its polarity inversed, e.g., “Vpix, Vcom”=“5V, 0V” to “0V, 5V”.

First, refer to a time t0′ where the pixel voltage Vpix is initially 5V (shown in dashed line) and the common voltage Vcom is initially 0V. Then, refer to a time t1′ where a sample operation is performed, which is similar to that in FIG. 4B. At this time, the sample voltage Vsample is about 4.5V (=5V−0.5V) since the capacitive element 220 has a large capacitance. After the sample operation, because there is a voltage different of 3V between first and second levels of the enabled signal CE, the enable signal CE is enabled to push up the sample voltage Vsample to about 7.5V (=4.5V+3V).

Then, refer to a time t2′ where a precharge state is performed. The gate control signal GATE is enabled at a high level to turn on the gate switch T. The refresh data signal SOURCE is enabled at a high level of, for example, 5V. Via the turn-on gate switch T, the enabled refresh data signal SOURCE of 5V is provided to maintain the pixel voltage Vpix of 5V at 5V, while the common voltage Vcom is flipped at this time. Thus, the image data storage capacitor C is neutralized, i.e., the voltage applied thereacross is 0V.

After that, refer to a time t3′ where a refresh state is performed. The refresh control signal REFRESH is enabled at a high level to turn on the third switch 213. At this time, the enable signal CE is disabled, and the sample voltage Vsample is pushed down to about 4.5V (=7.5V−3V). This sample voltage Vsample is still enough to turn on the second switch 212 since the refresh data signal SOURCE is at 0V. Specifically, the second switch 212 is turned on since the voltage difference of 4.5V (Vsample−SOURCE(t3)=4.5V−0V) is higher than its threshold voltage of 1V. Via the turn-on second and third switches 212 and 213, the refresh data signal SOURCE of 0V is provided to refresh the pixel voltage Vpix of 5V. Thus, as can be seen from time t1′ and time t3′ in FIG. 4C, when the refresh operation is performed in the second refresh scheme, the refreshed image data at time t3 (“Vpix, Vcom”=“5V, 0V”) has an inversed polarity as the polarity of the image data at time t1 (“Vpix, Vcom”=“0V, 5V”).

In the second refresh scheme, the image data of 0V is refreshed while its polarity inversed, e.g., “Vpix, Vcom”=“0V, 0V” to “5V, 5V”.

Similar operation can be referred to the image data of 5V in previous description, and is omitted for the sake of brevity. First, refer to the time t0′ where the pixel voltage Vpix is initially 0V (shown in solid line) and the common voltage Vcom is initially 0V. Then, refer to the time t1′. The sample voltage Vsample is about −0.5V (=0V−0.5V) since the capacitive element 220 has a large capacitance. After the sample state, the enable signal CE is enabled to push up the sample voltage Vsample to about 2.5V (=−0.5V+3V). Next, refer to time t2′. The gate switch T is turned on by the enabled gate control signal GATE. Via the turn-on gate switch T, the enabled refresh data signal SOURCE of 5V is provided to refresh the pixel voltage Vpix of 0V to 5V, while the common voltage Vcom is flipped. Thus, the image data storage capacitor C is neutralized, i.e., the voltage applied thereacross is 0V.

After that, refer to the time t3′. The sample voltage Vsample is pushed down to about −0.5V (=2.5V−3V). At this time, the second switch 212 is turned off, and the refresh data signal SOURCE of 0V is not provided to refresh the pixel voltage Vpix of 5V. Thus, as can be seen from time t1′ and time t3′ in FIG. 4C, when the refresh operation is performed in the second refresh scheme, the refreshed image data at time t3′ (“Vpix, Vcom”=“0V, 0V”) has the inversed polarity as the polarity of the image data at time t1′ (“Vpix, Vcom”=“5V, 5V”).

According to the second refresh scheme for use in image data of 5V and 0V, when the refresh operation is performed, the refreshed image data has the inversed polarity as the polarity of the image data stored in the image data storage capacitor C in the sample operation (“Vpix, Vcom”=“5V, 0V” to 0V, 5V″ and “Vpix, Vcom”=“0V, 0V” to “5V, 5V”). In this way, the effect of image sticking can be reduced. Image sticking occurs when a DC voltage applied across the image data storage capacitor for a long time. The second refresh scheme is used to inverse the polarity of the image data of the image data storage capacitor, so that the image sticking can be prevented.

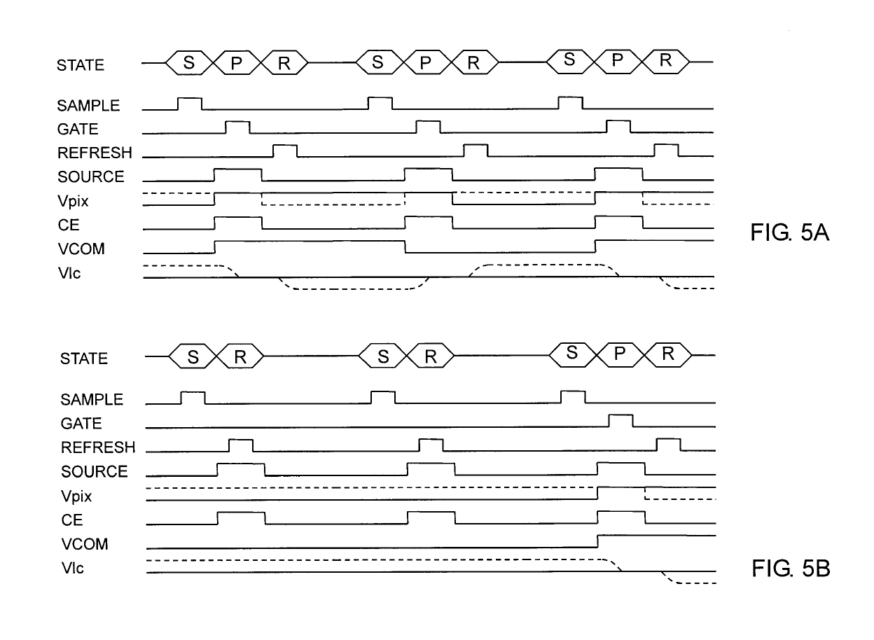

In an embodiment of this invention, a combined refresh scheme is implemented by selectively using the first and second refresh schemes aforementioned. In this way, not only power consumption can be reduced but image sticking can be improved. Further description is provided below with reference to FIGS. 5A and 5B.

FIG. 5A is a timing diagram showing a number of signal waveforms when the display panel executes the second refresh scheme during a refresh period in the refresh mode. FIG. 5B is a timing diagram showing a number of showing a number of signal waveforms when the display panel executes a combined refresh scheme during the same refresh period in the refresh mode according to one embodiment of the invention. In FIG. 5A, three times of the second refresh scheme are used to refresh the image data storage capacitor, wherein the polarity of applied voltage Vlc across the image data storage capacitor is inversed three times, as indicated by dashed line. In contrast thereto, in the example of FIG. 5B, two first refresh scheme followed by one second refresh scheme, wherein the applied voltage Vlc thereacross is inversed one time, as indicated by dashed line. As can be found from FIGS. 5A and 5B, the times for inversing the polarity of image data is reduced by using the combined refresh scheme in FIG. 5B, so that power consumption can thus be reduced by using the combined refresh scheme in FIG. 5B when compared with the power consumption by using the second refresh scheme in FIG. 5B.

In the example of FIG. 5B, the first refresh scheme is performed two times while the second refresh scheme one time. In another embodiment, the first refresh scheme can be performed ten times while the second refresh scheme one time, so as to further reduce power consumption. Performing more times of first refresh scheme than second refresh scheme means that the times for inversing the polarity of image data can be reduced to save power. In practice, the times for performing the first and second refresh further can be designed to meet different requirements, and not regarded as a limit of this invention.

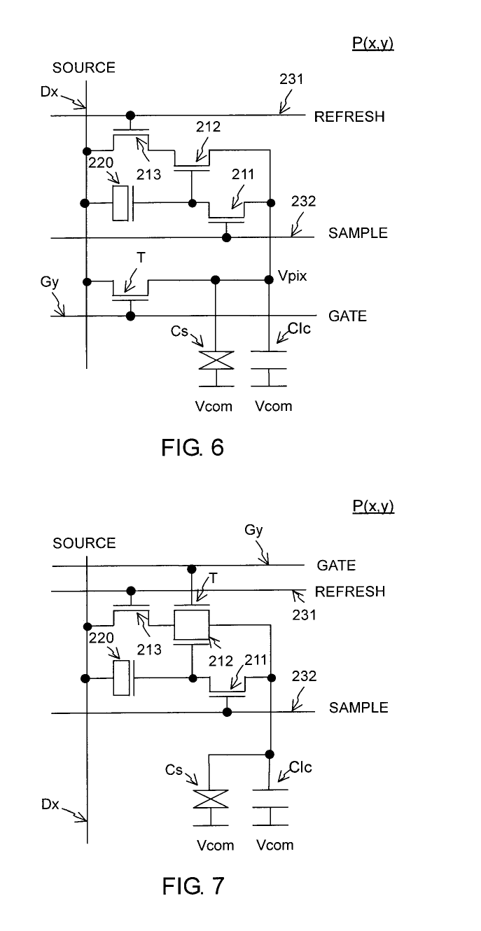

Besides, there are several circuit variations of the pixel element according to the embodiment of the current invention in FIG. 4A. Among them, another four embodiments of the pixel element are provided in FIGS. 6-9 for illustration.

FIG. 6 is a circuit diagram showing an example of the pixel element in FIG. 4A according to another embodiment of the invention. The pixel element in FIG. 6 differs with the pixel element in FIG. 4A in that the capacitive element 220 has the second terminal coupled to the corresponding source line Dx. In this way, the enable signal CE can be omitted, so can its additional transmission line.

FIG. 7 is a circuit diagram showing an example of the pixel element in FIG. 4A according to another embodiment of the invention. The pixel element in FIG. 7 differs with the pixel element in FIG. 2 in that the gate switch T has its two data terminals electrically connected with two data terminals of the second switch 212.

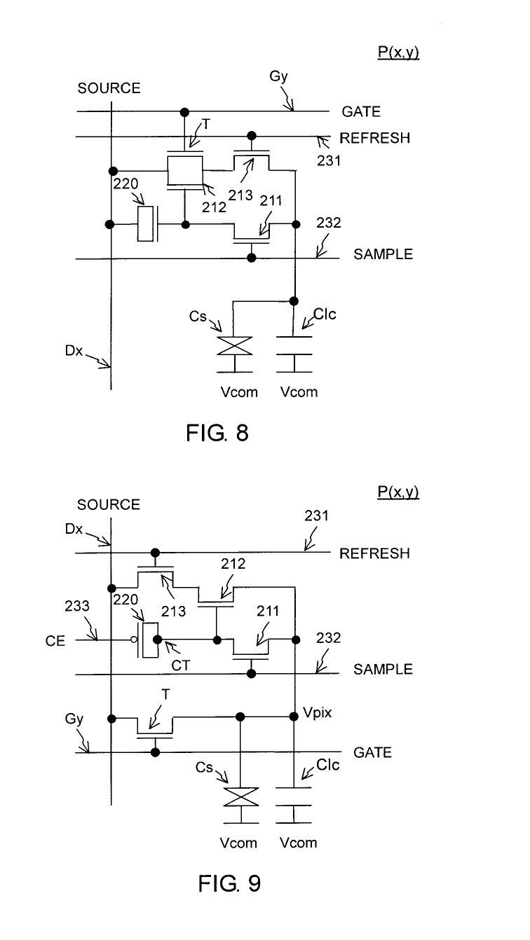

FIG. 8 a circuit diagram showing an example of the pixel element in FIG. 4A according to another embodiment of the invention. The pixel element in FIG. 8 differs with the pixel element in FIG. 7 in that the third switch 213 is coupled between the second switch 212 and the image data storage capacitor C.

FIG. 9 a circuit diagram showing an example of the pixel element in FIG. 4A according to another embodiment of the invention. The pixel element in FIG. 9 differs with the pixel element in FIG. 4A in that the capacitive element 220 is a p-type thin film transistor further having its source terminal and drain terminal electrically connected to the image data storage capacitor C and serve as the first terminal CT.

Employing the proper control signals, such as the sample control signal SAMPLE, gate control signal GATE, refresh control signal REFRESH, refresh data signal SOURCE, and enabled signal CE, as shown in FIGS. 4B and 4C,to the switches 212-213 and the gate switch T, the pixel elements in FIGS. 6-9 have the similar performance as that in FIG. 4A. As for the pixel elements in FIGS. 6-9, their operation, thus, can be conducted similarly with reference to the above-related description of the circuit in FIG. 4A and will not be specified for the sake of brevity.

According to the display panel, the pixel element and the control method thereof disclosed in the embodiments of the invention, a capacitive element with variable capacitance is used for storing the data of the image data storage capacitor. After the data of the image data storage capacitor is memorized in the capacitive element, the image data storage capacitor can be refreshed with its polarity remained. When the image data storage capacitor is refreshed, a combined refresh scheme of two refresh operations can be performed thereon. Based on the combined refresh scheme, the refreshed image data stored in the image data storage capacitor after refresh operation can selectively have the same polarity of the image data stored in the image data storage capacitor in the sample operation, thereby reducing power consumption.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A pixel element for use in an active matrix pixel array, the pixel element comprising:
an image data storage capacitor for storing an image data;
a gate switch having a control terminal coupled to a corresponding gate line, the gate switch being coupled between a corresponding source line and the image data storage capacitor; and
a refresh unit connected between the corresponding source line and the image data storage capacitor, the refresh unit being for performing a sample operation and a refresh operation on the image data storage capacitor,
wherein when the refresh unit performs the refresh operation, the refresh unit refreshes the image data stored in the image data storage capacitor, and the refreshed image data has the same polarity as the polarity of the image data stored in the image data storage capacitor in the sample operation.

2. The pixel element according to claim 1, wherein the refresh unit comprises:
a first switch having a control terminal for receiving a sample control signal;
a capacitive element having a first terminal coupled to a pixel electrode of the image data storage capacitor via the first switch, and the capacitive element having a capacitance varied with the applied voltage across the capacitive element;
a second switch having a control terminal coupled to the first terminal of the capacitive element; and
a third switch having a control terminal for receiving a refresh control signal, the third switch and the second switch being serially coupled with each other, the second switch and the third switch being coupled between a corresponding source line of the pixel element and the image data storage capacitor for receiving a refresh data signal.

3. The pixel element according to claim 1, wherein the capacitive element is a thin film transistor having a source terminal and a drain terminal electronically connected with each other.

4. The pixel element according to claim 3, wherein the thin film transistor is an n-type thin film transistor further having a control terminal serving as the first terminal.

5. The pixel element according to claim 3, wherein the thin film transistor is a p-type thin film transistor further having its source terminal and drain terminal electrically connected to the image data storage capacitor and serve as the first terminal.

6. The pixel element according to claim 1, wherein the capacitive element further has a second terminal for receiving an enable signal.

7. The pixel element according to claim 1, wherein the second switch is coupled between the third switch and the image data storage capacitor, or the third switch is coupled between the second switch and the image data storage capacitor.

8. A control method for use in an active matrix pixel array, the control method comprising the steps of:
storing an image data in an image data storage capacitor of the active matrix pixel array;
performing a sample operation to store the image data in a capacitive element; and
performing, based on the stored image data in the capacitive element, a refresh operation to refresh the image data stored in the image data storage capacitor, the refreshed image data in the image data storage capacitor has the same polarity as the polarity of the image data stored in the image data storage capacitor in the sample operation.

9. The method according to claim 8, further comprising, after the step of performing the refresh operation, the steps of:
performing another sample operation to store the image data in the capacitive element; and
performing another refresh operation to refresh the image data in the image data storage capacitor, the refreshed image data in the image data storage capacitor has an inversed polarity as the polarity of the image data stored in the image data storage capacitor in the another sample operation.

10. A display panel, comprising:
an active matrix pixel array comprising:
a plurality of gate lines;
a plurality of source lines;
a plurality of pixel elements arranged in a matrix, each pixel element being coupled to the corresponding gate line and source line, each pixel element being as claimed in claim 1;
a source driver for driving the source lines; and
a gate driver for driving the gate lines.
